(19) United States
(12) Patent Application Publication
(10) Pub. No.: US 2010/0255243 A1
(43) Pub. Date: Oct. 7, 2010

(54) CONCERNING A FACING BOARD, NOTABLY A PLASTER BOARD

(75) Inventors: Emmanuel Geeraert, Kapellen (BE); Yves Benkemoun, Rueil-Malmaison (FR); Laurent Bourdon, Cognac (FR); Rosa Casals, Saint-Cloud (FR); David Defendenti, Saint-Die (FR); Jacques Denimal, Compiegne (FR); Pierre Marie Duriaud, Andresy (FR); Alexandre Fritsch, Hoenheim (FR); Yves Hamelin, Evry (FR); Christine Laroulandie, Neuilly-sur-Seine (FR); Nadia Maimouni, Nanterre (FR); Aurelie Peraudeau, Saint-Cloud (FR); Fabien Peyrat, Bordeaux (FR); Pascal Pinede, Baron (FR); Patrick Rosique, Meximieux (FR); Marc Antoine Verhaeghe, Lille (FR)

Correspondence Address: YOUNG & THOMPSON, 209 Madison Street, Suite 500, Alexandria, VA, 22314, US

(73) Assignee: PLACOPLATRE, Suresnes (FR)

(21) Appl. No.: 12/447,297

(22) PCT Filed: Sep. 12, 2007
(86) PCT No.: PCT/FR2007/001470

§ 371 Date: Jun. 8, 2010

(30) Foreign Application Priority Data
Sep. 15, 2006 (FR) 0608077

(51) Int. Cl. E04C 2/30; E04C 2/52; B32B 29/00; B32B 3/04; B32B 3/02

(52) U.S. Cl. 428/61; 428/124; 428/172; 428/192; 428/157; 428/122

(57) ABSTRACT

A facing board, notably plaster board (2), according to the invention has a core (4) disposed between two sheets (6, 8) of card. One sheet (8) of card has a substantially straight cut (12) extending from one edge of the board to an opposite edge. The invention also provides for the core (4) to have a break (14) throughout its thickness, and for the sheet (6) of card opposite the cut sheet (8) to be folded at approximately 180° along the break (14).

The present invention concerns an improvement made to facing boards, notably plaster boards.

A plaster board has a plaster core sandwiched between two sheets of card. These boards are generally of rectangular shape and have two thinned opposite edges. Such plaster boards are perfectly familiar to the person skilled in the art.

One drawback of plaster boards is the difficulty of manipulating them and transporting them. This is due notably to the size of the boards and equally to their weight. Plaster boards generally have a length exceeding two meters so that it is possible to produce vertical partition walls without having to place two boards one above the other.

An object of the present invention is therefore to provide means for facilitating the manipulation and/or the transportation of a plaster board.

To this end, it proposes a facing board, notably plaster board, having a core disposed between two sheets of card.

According to the present invention, one sheet of card has a substantially straight cut extending from one edge of the board to an opposite edge.

The cut produced in this way in the sheet of card forms a break line for the core of the facing board. An impact then breaks the core of the board along the cut. The two parts of the core of the facing board, on either side of the break, can then pivot relative to each other, the second sheet of card forming a hinge. By pivoting 180°, the two parts of the facing board come face to face, thus limiting the overall size of the board in one dimension, the length for example.

To facilitate the breakage of the core, the latter can have a nick at the location of the cut produced in the card, over at least a part of the length of that cut. The present invention further concerns a facing board as defined here that also has a break produced in the core of the board at the location of the cut (and/or the nick). This cut (and where appropriate the nick if present) can be covered, totally or partially, by a glue seal.

A facing board of the invention is rectangular, for example, and has two opposite thinned edges. Its cut then advantageously extends from one thinned edge to the other thinned edge, perpendicularly to the latter. The thinned edges are generally produced on the longitudinal edges of the facing board (thus corresponding to the long sides of the board). Such a cut then reduces the overall length of the facing board when the latter is folded.

In a preferred embodiment, one face of the facing board covered with card is a plane face and the cut is produced on that plane face. The other face, which then serves as a hinge, can then be used as the front face of the facing board, that is to say the visible face of the board when the latter has been installed. Accordingly, once the facing board has been installed, the cut, where applicable the nick, and the break are invisible.

The sheet of card opposite the cut sheet advantageously has a mass per unit area greater than 200 g/m², for example 240 g/m². Such a sheet of card is stronger than the sheets of card usually employed to produce plaster facing boards and can be folded and unfolded a number of times without tearing.

The present invention equally concerns a facing board as described above the core of which has a break throughout its thickness and for which the sheet of card opposite the cut sheet is folded at approximately 180° along the break. To protect the break of such a facing board, the break is advantageously wrapped by a sheet of paper. It can equally be envisaged that the free edges of the board opposite the break are also wrapped by a sheet of paper.

The present invention further concerns a set of facing boards having a break at the location of the core and a 180° fold, characterized in that the boards are stacked one on the other. In this stack, the breaks are preferably disposed one above the other and are wrapped by a sheet of paper. In such a set of boards the board edges opposite the breaks can equally be wrapped by a sheet of paper.

Details and advantages of the present invention will emerge better from the following description, given with reference to the appended diagrammatic drawings in which:

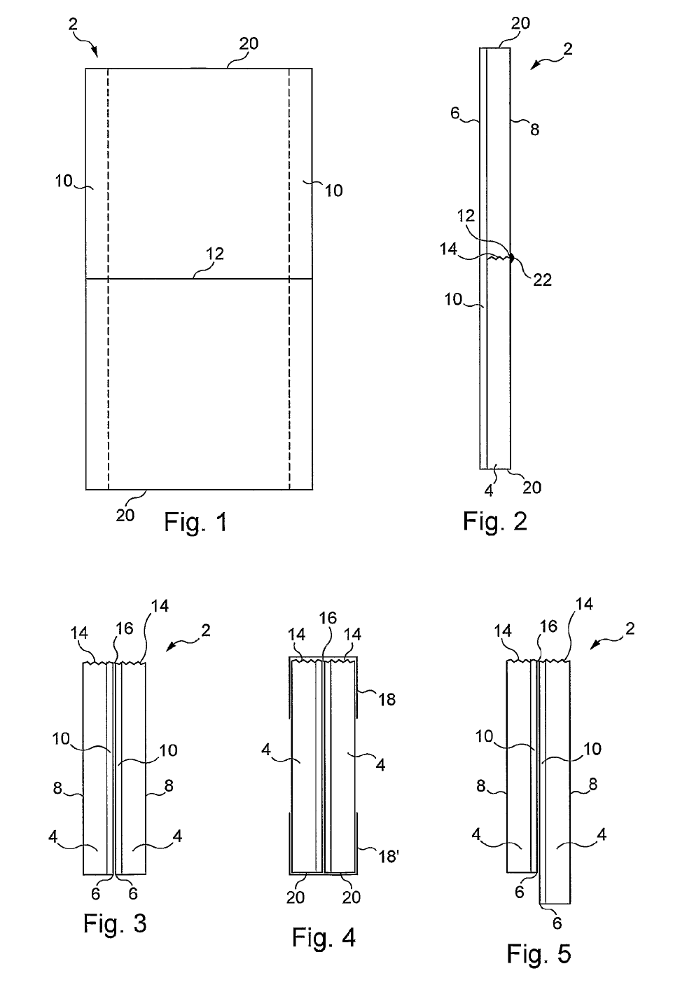

FIG. 1 is a front view of a board of the invention,

FIG. 2 is a side view of the board from FIG. 1,

FIG. 3 corresponds to FIG. 2, the board being folded,

FIG. 4 shows diagrammatically the packaging of a folded board, and

FIG. 5 is a view similar to that of FIG. 3 for a different embodiment.

The drawings represent a plaster board that overall has the same shape as a prior art plaster board. This plaster board 2 has a plaster core 4 sandwiched between two sheets of card: a front sheet 6 and a back sheet 8. The front sheet 6 is so called because it is the sheet of card intended to be visible when the plaster board 2 has been installed. Thus the back sheet 8 is hidden when the plaster board 2 has been installed.

In a manner that is also known, the plaster board 2 has two thinned edges 10. The plaster board 2 represented is a rectangular board and the thinned edges 10 are produced on one face of the plaster board 2 at the location of the longitudinal edges (long sides) of the rectangular plaster board 2. In a known manner, these thinned edges 10 are produced on the front face of the plaster board 2. The sheet 6 of card is therefore substantially plane over the whole of the surface of the plaster board 2 except at the location of the long sides of this board where the front sheet 6 is slightly inclined to form a thinned edge 10. The back sheet 8 is substantially plane over the whole of the surface of the plaster board 2.

Such a plaster board structure is known from the prior art.

According to the present invention, one sheet of card of this plaster board 2 is cut along a straight cut extending from one edge to the other of the board.

In the embodiment represented in the drawings, there is recognized in FIG. 1 a cut 12 produced in the back sheet 8 and extending from one longitudinal edge to the other. This cut 12 is a transverse cut, parallel to the short sides of the plaster board 2 and equidistant from them. To summarize, the cut 12 is therefore a transverse cut produced at the mid-height of the plaster board 2 on the rear face of the latter.

The cut 12 is for example a continuous cut produced by means of a sharp tool. This cut is preferably produced through the entire thickness of the sheet 8 of card. It can be envisaged here to have either a continuous cut or a dashed cut.

During the production of the cut 12, a nick is produced in the core 4 of the board. This nick coincides in the figures with the cut 12. It is shallow: it has a depth of the order of one millimeter, for example. Its depth is advantageously less than ⅕, or preferably 1/10, of the thickness of the core 4. This nick is produced simultaneously with the cut 12, with the same tool (not shown) that produces the cut 12.

The cut 12 and the corresponding nick enable a break 14 to be produced in the core 4 of the plaster board 2. This break 14 extends along the cut 12 and is represented in FIGS. 2 to 4. When this break 14 has been produced, the plaster board 2 can be folded, the front sheet 6 of card then fulfilling the hinge function.

FIGS. 3 and 4 represent a plaster board 2 in which a 180° fold 16 has been produced along the break 14. There are obtained in this way two plaster half-boards disposed face to face having a front sheet of card in one piece. The overall height of the plaster board 2 has therefore been reduced by half. The overall width is retained and the overall thickness is doubled. In this way, the thickness of the board being virtually negligible compared to the length and the width of the latter, the plaster board 2 can be transported and manipulated more easily.

FIG. 4 shows a different embodiment. There are recognized here the plaster board 2 with a 180° fold 16 in the front sheet 6 from FIG. 3. In this embodiment, the break 14 is wrapped in a sheet 18 of paper. The latter therefore wraps the break 14 as well as the back sheet 8 of the plaster board near the break 14.

There can equally be provision, as represented in FIG. 4, for also wrapping together the two transverse edges 20 of the plaster board 2. A sheet 18′ of paper is used for this purpose. Like the sheet 18 of paper, it is a question here for example of a sheet produced in a paper of the type used commonly in the field of packaging. Other materials, for example a synthetic material, may be envisaged here.

The sheets 18 and 18′ of paper are applied in the factory manufacturing the plaster boards, for example. These folded plaster boards can be stacked one on the other, in the same way that plaster boards are stacked. It may be envisaged to wrap individually the breaks 14 of a number of plaster boards stacked one on the other and/or to wrap together all the superposed breaks. Similarly, packaging for the transverse edges of the plaster boards two by two can be provided and/or packaging for all the superposed transverse edges of a stack of folded plaster boards of the invention.

The present invention can be applied to all the dimensions of plaster board. For example, an unfolded plaster board has for example a height of 2500 mm and a width of 600 or 1200 mm. The thickness of the core 4 of the board is for example of the order of 10 or 13 mm. These are the dimensions of commonly used plaster boards. All other dimensions can be envisaged here.

The front sheet 6, intended to be folded, is advantageously produced in a card having a mass per unit area greater than 200 g/m², for example 240 g/m². However, the invention can be implemented with a sheet of “standard” card having a lower weight per unit area.

When a board 2 that has been folded is unfolded, as represented in FIG. 2, the two plaster half-boards nest perfectly together at the location of the break 14. The plaster board 2 unfolded in this way then has an appearance virtually identical to that of a prior art plaster board with the same dimensions. Only the cut 12 and the corresponding nick in the core 4 are apparent on the back of the board, that is to say on the side that is normally hidden once the board has been installed. Providing a break in the core 4 and not a cut enables perfect repositioning of the two parts of the plaster board 2 when it is unfolded. A break means that the fold can be produced without removing material from the plaster core 4. As shown in FIG. 2, after it has been folded for handling and unfolded for installation, the board 2 can receive a glue seal 22 that covers the cut 12 and the nick, preferably over virtually all their length, except at the ends, so as not to impede the fitting and fixing of the board to uprights of a framework.

The present invention thus proposes a solution facilitating manipulation and transportation of plaster boards. These boards have an overall dimension, for example an overall height, that is reduced without it being necessary to provide a greater number of joints when producing a wall.

Installing such a plaster board is easy. When the ends of the folded plaster board are wrapped by a sheet of paper, the two half-boards are perfectly fastened together. Before use, the sheets 18 and/or 18′ of paper are removed. The board is then put into place and then unfolded. Thus it is not necessary to manipulate the unfolded board. The glue seal can be applied here.

FIG. 5 illustrates a different embodiment in which the break 14, and therefore also the cut 12 and the corresponding nick, are not produced at the mid-height of the facing board 2 but with a slight offset. Accordingly, when the board 2 is folded (FIG. 5), the top edge and the bottom edge are offset. This small offset, for example of the order of one centimeter to a few centimeters, is intended to facilitate the unfolding of the board 2.

The present invention is not limited to the embodiment and its variants described by way of nonlimiting example. It concerns equally all other variants obvious to the person skilled in the art.

The description that is given above concerns a board with two thinned edges. The cut and the break produced are perpendicular to the thinned edges. This then limits the overall length of the board. A cut (with or without corresponding nick) and a break parallel to the thinned edges can equally be envisaged. There is then obtained a board whose overall width is limited when it is folded.

The present invention can equally be implemented with composite facing boards including a core in a material similar to plaster sandwiched between two sheets of card.

The above description concerns the preferred embodiment in which the cut (and where applicable the nick) is produced on the rear face (not visible after installation) of a facing board. In some cases this cut can be produced on the front face of the board, that in which the thinned edges are generally produced.

The present invention also concerns facing boards having a lining, such as expanded polystyrene (EPS) for example. In such a board, the cut is produced both in the lining and in the adjacent sheet of card, the nick being produced where applicable in the core of the board.

1-12. (canceled)

13. Facing board, notably plaster board (2), having a core (4) disposed between two sheets (6, 8) of card,
characterized in that only one sheet (8) of card has a cut (12), and in that said cut (12) is substantially straight and extends from one edge of the board to an opposite edge.

14. Facing board, notably plaster board (2), having a core (4) disposed between two sheets (6, 8) of card,
characterized in that one sheet (8) of card has a substantially straight cut (12) extending from one edge of the board to an opposite edge, and in that the core has a nick at the location of the cut (12) over at least a part of the length of the latter.

15. Facing board according to claim 14, characterized in that the nick is shallow and has a depth of the order of one millimeter.

16. Facing board according to claim 13, characterized in that a break is produced in the core of the facing board at the location of the cut (12).

17. Facing board according to claim 16, characterized in that the cut (12) is covered by a glue seal (22).

18. Facing board according to claim 13, characterized in that it is rectangular, in that it has two opposite thinned edges (10), and in that the cut (12) extends from one thinned edge (10) to the other thinned edge (10), perpendicularly to the latter.

19. Facing board according to claim 13, characterized in that one face of the facing board (2) covered with card is a plane face and in that the cut (12) is produced on that plane face.

20. Facing board according to claim 13, characterized in that the sheet (6) of card opposite the cut sheet (8) has a mass per unit area greater than 200 g/m².

21. Facing board according to claim 13, characterized in that the core (4) has a break (14) throughout its thickness, and in that the sheet (6) of card opposite the cut sheet (8) is folded at approximately 180° along the break (14).

22. Facing board according to claim 21, characterized in that the break (14) is wrapped by a sheet (18) of paper, and in that the free edges of the board opposite the break (14) are wrapped by a sheet (18′) of paper.

23. Set of facing boards (2) according to claim 21, characterized in that the boards (2) are stacked one on the other.

24. Set of boards according to claim 23, characterized in that the breaks (14) are disposed one above the other and in that they are wrapped by a sheet (18) of paper.

25. Set of boards according to claim 24, characterized in that the board edges opposite the breaks (14) are wrapped by a sheet (18′) of paper.

26. Facing board according to claim 14, characterized in that a break is produced in the core of the facing board at the location of the cut (12).

27. Facing board according to claim 15, characterized in that a break is produced in the core of the facing board at the location of the cut (12).

28. Facing board according to claim 14, characterized in that it is rectangular, in that it has two opposite thinned edges (10), and in that the cut (12) extends from one thinned edge (10) to the other thinned edge (10), perpendicularly to the latter.

29. Facing board according to claim 15, characterized in that it is rectangular, in that it has two opposite thinned edges (10), and in that the cut (12) extends from one thinned edge (10) to the other thinned edge (10), perpendicularly to the latter.

30. Facing board according to claim 16, characterized in that it is rectangular, in that it has two opposite thinned edges (10), and in that the cut (12) extends from one thinned edge (10) to the other thinned edge (10), perpendicularly to the latter.

31. Facing board according to claim 17, characterized in that it is rectangular, in that it has two opposite thinned edges (10), and in that the cut (12) extends from one thinned edge (10) to the other thinned edge (10), perpendicularly to the latter.

32. Facing board according to claim 14, characterized in that one face of the facing board (2) covered with card is a plane face and in that the cut (12) is produced on that plane face.
